(19) United States
(12) Patent Application Publication
(10) Pub. No.: US 2013/0212744 A1
(43) Pub. Date: Aug. 15, 2013

(54) METHOD OF REDUCING INSECT-VECTORED VIRAL INFECTIONS

(71) Applicants: Naglaa Monir, Kaha (EG); Domingos Pedroni, Sao Paulo (BR); Robert Senn, Basel (CH)

(72) Inventors: Naglaa Monir, Kaha (EG); Domingos Pedroni, Sao Paulo (BR); Robert Senn, Basel (CH)

(73) Assignee: SYNGENTA CROP PROTECTION LLC, Greensboro, NC (US)

(21) Appl. No.: 13/695,410

(22) PCT Filed: Apr. 21, 2011
(86) PCT No.: PCT/EP2011/056390

§ 371 Date: Jan. 14, 2013

(30) Foreign Application Priority Data
Apr. 30, 2010 (EP) 10161627.4

(51) Int. Cl. A01N 43/82; A01N 43/56

(52) U.S. Cl. CPC A01N 43/82; A01N 43/56
USPC 800/298; 514/341

(57) ABSTRACT

The present invention is directed to methods of reducing insect-vectored viral infection and transmission in plants, methods of reducing damage to plants caused by viral infection, and methods of crop enhancement including methods for improving plant growth, vigour and yield, by application of a combination of an anthranilic bis-amide or an aminothiadiazole (ryanodine receptor modulator) insecticide and a plant activator, to compositions comprising the combinations and to plant propagation material treated therewith.

The present invention is directed to methods of reducing insect-vectored viral infection and transmission in plants, methods of reducing damage to plants caused by viral infection, methods of crop enhancement including methods for improving plant growth, vigour and yield, by application of a combination of an anthranilic bis-amide or an aminothiadiazole (ryanodine receptor modulator) insecticide and a plant activator, to compositions comprising the combinations and to plants and plant propagation material treated therewith.

The agrochemical industry is continually seeking methods of controlling plant pests and improving the growth of plants. Chemicals are typically used (i) to control undesirable species (for example, pests, such as insects, or vegetation, e.g., weeds, or fungi), and (ii) to promote plant growth (e.g., by providing nutrients), and thereby improve the growth of plants. Insect-vectored viral infections are a widespread cause of plant damage, for which there are few effective measures of control.

International patent application WO 2003/016284 and European patent application EP 1,717,237 refer to substituted anthranilamides for controlling invertebrate pests. International patent application WO 04/067528 refers to a series of cyanthranilamide insecticides. International patent application WO 2005/107468 refers to pesticidal compositions comprising anthranilamides in admixture with other agrochemicals. International patent application WO 2006/108552 refers to pesticidal compositions comprising bis-amide insecticides and fungicides for controlling pests, such as insects and acarids and also undesirable phytopathogenic fungi. United States patent application US 2009/0275471 refers to insecticidal compositions comprising anthranilamides in combination in combination with insecticides, fungicides and acaricides. International patent application WO 2008/020998 refers to the in-furrow fungicide application for reducing plant damage by control of insect-vectored viral infection. International patent applications WO 2008/021152 and WO 2008/122396 refer to the use of anthranilamides for increasing crop vigour and yield.

Chlorantraniliprole (3-bromo-4′-chloro-1-(3-chloro-2-pyridyl)-2′-methyl-6′-(methylcarbamoyl)-pyrazole-5-carboxanilide), is an anthranilic bis-amide insecticide registered in, inter alia, the United States, for use on crops for the control of pests such as moths, beetles and caterpillars and sold under the trade name Rynaxypyr™. Cyantraniliprole (3-bromo-1-(3-chloro-2-pyridyl)-4′-cyano-2′-methyl-6′-(methylcarbamoyl)pyrazole-5-carboxanilide), is an anthranilic bis-amide insecticide registered in, inter alia, the United States, for use on tree, vine and vegetable crops. Acibenzolar (benzo[1,2,3]thiadiazole-7-carbothioic S-acid), acibenzolar-S-methyl (S-methyl benzo[1,2,3]thiadiazole-7-carbothioate), and probenazole (3-allyloxy-1,2-benzothiazole 1,1-dioxide), are plant activators that are used for controlling fungi and bacteria.

There exists a need for alternative methods for controlling insect-vectored viral infection and transmission in plants, and for reducing the damage to plants caused by such viral infections, especially useful plants such as crops.

It has now been surprisingly found that a combination comprising an anthranilic bis-amide or an aminothiadiazole (ryanodine receptor modulator) insecticide and a plant activator is particularly effective in reducing viral infection and transmission in plants. The effect produced by the combination is greater than would be expected by the use of the individual components and is therefore synergistic.

Accordingly, in one aspect, the present invention provides a method of reducing insect-vectored viral infection in a plant by application of a combination of an anthranilic bis-amide insecticide of formula (I)

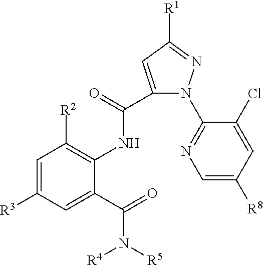

wherein
R¹ is halogen, C₁-C₄haloalkyl or C₁-C₄haloalkoxy;
R² is halogen or C₁-C₄alkyl;
R³ is halogen or cyano;
R⁴ is hydrogen or C₁-C₄alkyl;
R⁵ is hydrogen, C₁-C₄alkyl, C₃-C₄cycloalkyl-C₁-C₄alkyl, NR⁶R⁷,
R⁶ is hydrogen or C₁-C₄alkyl; and
R⁷ is C(O)OC₁-C₄alkyl;
R⁸ is hydrogen or halogen;
   or of a compound of formula II

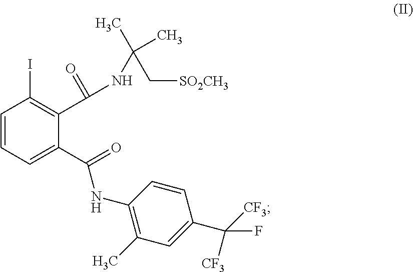 [SMILES: Cc1cc(C(F)(C(F)(F)F)C(F)(F)F)ccc1NC(=O)c1cccc(I)c1C(=O)NC(C)(C)CS(C)(=O)=O]

or of a compound of formula III

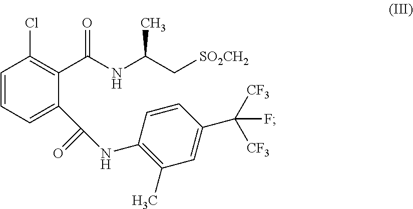

or an aminothiadiazole (ryanodine receptor modulator) compound of formula IV;

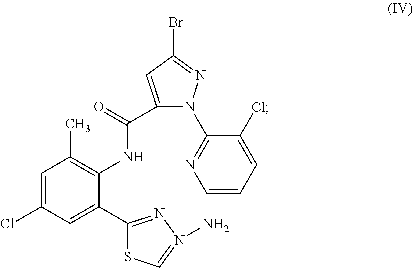

and a plant activator.

Halo and halogen mean fluoro, chloro, bromo or iodo.

Alkyl groups may be straight or branched. Representative alkyl groups include, for example, methyl, ethyl, n-propyl, isopropyl, n-butyl and t-butyl. Representative alkoxy groups include, for example, methoxy, ethoxy, isopropoxy and t-butoxy. Cycloalkyl groups include cyclopropyl and cyclobutyl.

Agrochemically acceptable salts possess a cation, which is known and accepted in the art for the formation of salts for agricultural or horticultural use. Preferably, the salts are water-soluble. References to a compound of formula (I), (II), (III) or (IV) herein shall be deemed to also include agrochemically acceptable salts thereof.

The active agents of the invention may be applied as sole ingredients, or alternatively, each agent may be in the form of an agrochemical composition comprising an agrochemically acceptable diluent or carrier. References herein to the active agents of the invention or components comprising said agents shall be deemed to include the agents as sole ingredients or agrochemical compositions thereof.

The active agents of the invention may be applied simultaneously, separately or sequentially. Each active agent may be applied directly as separate components or as a mixture of the two. References herein to a combination of a compound of formula (I), (II), (III) or (IV) and a plant activator, and preferred embodiments thereof, shall be deemed to include the active agents as separate individual ingredients or as a mixture of the two, or agrochemical compositions of said individual ingredients, or mixture thereof, comprising an agrochemically acceptable diluent or carrier.

In one embodiment, the present invention is directed to a composition comprising an a compound of formula (I), (II), (III) or (IV), and a plant activator.

The combinations of the invention may be applied to the plant, plant propagation material or locus thereof, or any combination thereof. Accordingly, the present invention provides methods as described herein comprising the application of a combination of the invention to a plant, plant propagation material or locus thereof, or any combination thereof.

In an additional aspect, the present invention provides a method of reducing insect-vectored-viral transmission amongst plants by application of a combination of a compound of formula (I), (II), (III) or (IV) and a plant activator.

In a further aspect, the present invention provides a method of reducing damage to a plant caused by one or more insect-vectored viral infections, by application of a combination of a compound of formula (I), (II), (III) or (IV) and a plant activator.

In a further aspect, the present invention provides a method of improving the growth of a plant by application of a combination of a compound of formula (I), (II), (III) or (IV) and a plant activator.

In a further aspect, the present invention provides a method of increasing the yield of a plant by application of a combination of a compound of formula (I), (II), (III) or (IV) and a plant activator.

In a further aspect, the present invention provides a method of improving plant vigour by application of a combination of a compound of formula (I), (II), (III) or (IV) and a plant activator.

In a further aspect, the present invention provides a method of improving the tolerance of plants to abiotic stress by application of a combination of a compound of formula (I), (II), (III) or (IV) and a plant activator.

In additional aspects, the present invention provides a combination of a compound of formula (I), (II), (III) or (IV) and a plant activator for use in the methods of the present invention.

In additional aspects, the present invention provides a synergistic combination of a compound of formula (I), (II), (III) or (IV) and a plant activator for use in the methods of the present invention.

In further additional aspects, the present invention provides for the use of a combination of a compound of formula (I), (II), (III) or (IV) and a plant activator in the methods of the present invention.

In further additional aspects, the present invention provides for the use of a synergistic combination of a compound of formula (I), (II), (III) or (IV) and a plant activator in the methods of the present invention.

In yet further additional aspects, the present invention provides a kit of parts suitable for use in the methods of the present invention, comprising a first component comprising a compound of formula (I), (II), (III) or (IV) and a second component comprising a plant activator, for the simultaneous, separate or sequential application to a plant, plant propagation material or locus thereof.

In yet further additional aspects, the present invention provides a kit of parts suitable for use in the methods of the present invention, comprising a first component comprising a compound of formula (I), (II), (III) or (IV) and a second component comprising a plant activator, for the simultaneous, separate or sequential application to a plant, plant propagation material or locus thereof, wherein the ratios of components provide a synergistic effect.

Preferred compounds of formula (I) for use in the methods of the present invention are:

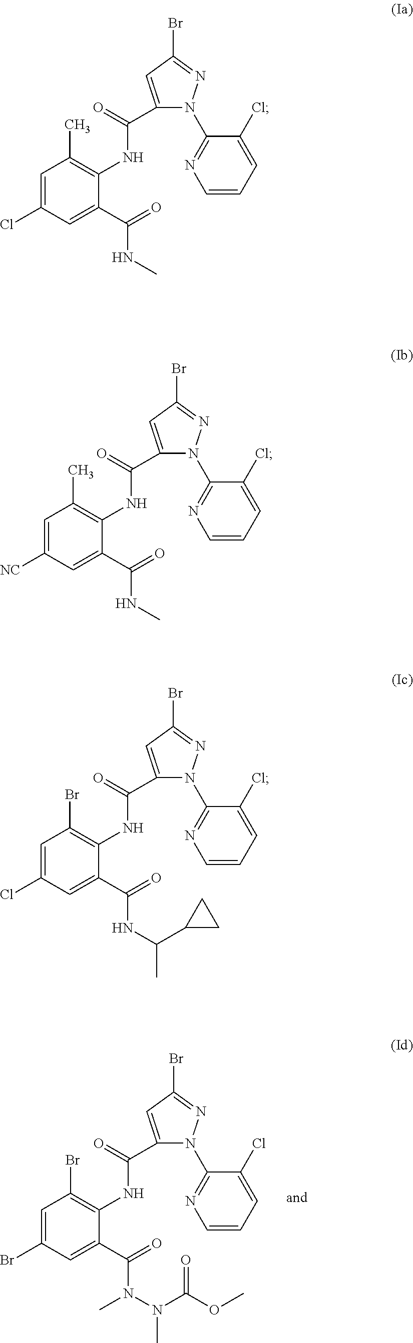 [SMILES: CNC(=O)c1cc(Cl)cc(C)c1NC(=O)c1cc(Br)nn1-c1ncccc1Cl ; CNC(=O)c1cc(C#N)cc(C)c1NC(=O)c1cc(Br)nn1-c1ncccc1Cl ; CC(NC(=O)c1cc(Cl)cc(Br)c1NC(=O)c1cc(Br)nn1-c1ncccc1Cl)C1CC1 ; COC(=O)N(C)N(C)C(=O)c1cc(Br)cc(Br)c1NC(=O)c1cc(Br)nn1-c1ncccc1Cl]

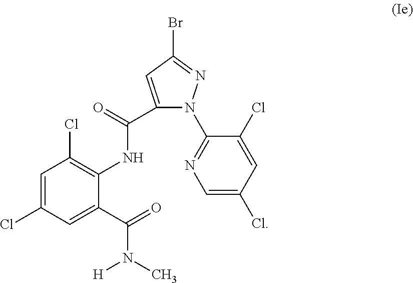 [SMILES: CNC(=O)c1cc(Cl)cc(Cl)c1NC(=O)c1cc(Br)nn1-c1ncc(Cl)cc1Cl]

The compound of formula (Ia) is known as chlorantraniliprole, the compound of formula (Ib) is known as cyantraniliprole and the compound of formula (II) is known as flubendiamide. In preferred embodiments of the invention, the compound of formula (I) is chlorantraniliprole or cyantraniliprole. In the most preferred embodiments of the invention, the compound of formula (I) is cyantraniliprole.

Plant activators are substances that protect plants by activating their defence mechanisms against pests or diseases. Plant activators suitable for use in the methods of the present invention include, for example, acibenzolar, acibenzolar-S-methyl and probenazole. Mixtures of plant activators can also be used in the present invention. In preferred embodiments of the invention, the plant activator is acibenzolar-S-methyl.

Accordingly, in a first preferred aspect, the present invention provides a method of reducing insect-vectored viral infection in a plant by application of a combination of a compound of formula (Ia), (Ib), (Ic), (Id), (Ie), (II), (III) or (IV), and acibenzolar-S-methyl. In a preferred embodiment, the present invention provides a method of reducing insect-vectored viral infection in a plant by application of a combination of chlorantraniliprole or cyantraniliprole, and acibenzolar-S-methyl. In a more preferred embodiment, the present invention provides a method of reducing insect-vectored viral infection in a plant by application of a combination of cyantraniliprole and acibenzolar-S-methyl.

In an additional preferred aspect, the present invention provides a method of reducing insect-vectored viral transmission amongst plants by application of a combination of a compound of formula (Ia), (Ib), (Ic), (Id), (Ie), (II), (III) or (IV), and acibenzolar-S-methyl. In a preferred embodiment, the present invention provides a method of reducing insect-vectored viral transmission amongst plants by application of a combination of chlorantraniliprole or cyantraniliprole, and acibenzolar-S-methyl. In a more preferred embodiment, the present invention provides a method of reducing insect-vectored viral transmission amongst plants by application of a combination of cyantraniliprole and acibenzolar-S-methyl.

In a further preferred aspect, the present invention provides a method of reducing damage to a plant caused by one or more insect-vectored viral infections, by application of a combination of a compound of formula (Ia), (Ib), (Ic), (Id), (Ie), (II), (III) or (IV), and acibenzolar-S-methyl. In a preferred embodiment, the present invention provides a method of reducing damage to a plant caused by one or more insect-vectored viral infections, by application of a combination of chlorantraniliprole or cyantraniliprole, and acibenzolar-S-methyl. In a more preferred embodiment, the present invention provides a method of reducing damage to a plant caused by one or more insect-vectored viral infections, by application of a combination of cyantraniliprole and acibenzolar-S-methyl.

In a further preferred aspect, the present invention provides a method of improving the growth of a plant by application of a combination of a compound of formula ((Ia), (Ib), (Ic), (Id), (Ie), (II), (III) or (IV), and acibenzolar-S-methyl. In a preferred embodiment, the present invention provides a method of improving the growth of a plant by application of a combination of chlorantraniliprole or cyantraniliprole, and acibenzolar-S-methyl. In a more preferred embodiment, the present invention provides a method of improving the growth of a plant by application of a combination of cyantraniliprole and acibenzolar-S-methyl.

In a further preferred aspect, the present invention provides a method of increasing the yield of a plant by application of a combination of a compound of formula (Ia), (Ib), (Ic), (Id), (Ie), (II), (III) or (IV), and acibenzolar-S-methyl. In a preferred embodiment, the present invention provides a method of increasing the yield of a plant by application of a combination of chlorantraniliprole or cyantraniliprole, and acibenzolar-S-methyl. In a more preferred embodiment, the present invention provides a method of increasing the yield of a plant by application of a combination of cyantraniliprole and acibenzolar-S-methyl.

In a further preferred aspect, the present invention provides a method of improving plant vigour by application of a combination of a compound of formula (Ia), (Ib), (Ic), (Id), (Ie), (II), (III) or (IV), and acibenzolar-S-methyl. In a preferred embodiment, the present invention provides a method of improving plant vigour by application of a combination of chlorantraniliprole or cyantraniliprole, and acibenzolar-S-methyl. In a more preferred embodiment, the present invention provides a method of improving plant vigour by application of a combination of cyantraniliprole and acibenzolar-S-methyl.

In a further preferred aspect, the present invention provides a method of improving the tolerance of plants to abiotic stress by application of a combination of a compound of formula (Ia), (Ib), (Ic), (Id), (Ie), (II), (III) or (IV), and acibenzolar-S-methyl. In a preferred embodiment, the present invention provides a method of improving plant vigour by application of a combination of chlorantraniliprole or cyantraniliprole, and acibenzolar-S-methyl. In a more preferred embodiment, the present invention provides a method of improving plant vigour by application of a combination of cyantraniliprole and acibenzolar-S-methyl.

In additional preferred aspects, the present invention provides a combination of a compound of formula (Ia), (Ib), (Ic), (Id), (Ie), (II), (III) or (IV), and acibenzolar-S-methyl, for use in the methods of the present invention. In a preferred embodiment, the present invention provides a combination of chlorantraniliprole or cyantraniliprole, and acibenzolar-S-methyl, for use in the methods of the present invention. In a more preferred embodiment, the present invention provides a combination of cyantraniliprole and acibenzolar-S-methyl, for use in the methods of the present invention.

In further additional preferred aspects, the present invention provides for the use of a combination of a compound of formula (Ia), (Ib), (Ic), (Id), (Ie), (II), (III) or (IV), and acibenzolar-S-methyl, in the methods of the present invention. In a preferred embodiment, the present invention provides for the use of a combination of chlorantraniliprole or cyantraniliprole, and acibenzolar-S-methyl, in the methods of the present invention. In a more preferred embodiment, the present invention provides for the use of a combination of cyantraniliprole and acibenzolar-S-methyl, in the methods of the present invention.

In yet additional preferred aspects, the present invention provides a kit of parts suitable for use in the methods of the present invention, comprising a first component comprising a compound of formula (Ia), (Ib), (Ic), (Id), (Ie), (II), (III) or (IV) and a second component comprising acibenzolar-S-methyl, for the simultaneous, separate or sequential application to a plant, plant propagation material or locus thereof. In a preferred embodiment, the present invention provides a kit of parts suitable for use in the methods of the present invention, comprising a first component comprising chlorantraniliprole or cyantraniliprole, and a second component comprising acibenzolar-S-methyl, for the simultaneous, separate or sequential application to a plant, plant propagation material or locus thereof. In a more preferred embodiment, the present invention provides a kit of parts suitable for use in the methods of the present invention, comprising a first component comprising cyantraniliprole and a second component comprising acibenzolar-S-methyl, for the simultaneous, separate or sequential application to a plant, plant propagation material or locus thereof.

The term “Locus” means the fields on which the plants to be treated are growing, or where the seeds of cultivated plants are sown, or the place where the seed will be placed into the soil.

The term “increasing the yield” of a plant means that the yield of a product of the plant is increased by a measurable amount over the yield of the same product of the plant produced under the same conditions, but without the application of the combinations according to the present invention. It is preferred that the yield is increased by at least about 0.5%, preferably 1%, more preferably 2%, yet more preferably 4% or more. Even more preferred is an increase in yield of at least about 5%, 10%, 15% or 20% or more.

According to the present invention, ‘crop enhancement’ means an improvement in plant vigour, an improvement in plant quality and/or improved tolerance to stress factors.

According to the present invention, an ‘improvement in plant vigour’ means that certain traits are improved qualitatively or quantitatively when compared with the same trait in a control plant which has been grown under the same conditions in the absence of the method of the invention. Such traits include, but are not limited to, early and/or improved germination, improved emergence, the ability to use less seeds, increased root growth, a more developed root system, increased root nodulation, increased shoot growth, increased tillering, stronger tillers, more productive tillers, increased or improved plant stand, less plant verse (lodging), an increase and/or improvement in plant height, an increase in plant weight (fresh or dry), bigger leaf blades, greener leaf colour, increased pigment content, increased photosynthetic activity, earlier flowering, longer panicles, early grain maturity, increased seed, fruit or pod size, increased pod or ear number, increased seed number per pod or ear, increased seed mass, enhanced seed filling, less dead basal leaves, delay of senescence, improved vitality of the plant, increased levels of amino acids in storage tissues and/or less inputs needed (e.g. less fertiliser, water and/or labour needed). A plant with improved vigour may have an increase in any of the aforementioned traits or any combination or two or more of the aforementioned traits.

According to the present invention, an ‘improvement in plant quality’ means that certain traits are improved qualitatively or quantitatively when compared with the same trait in a control plant which has been grown under the same conditions in the absence of the method of the invention. Such traits include, but are not limited to, improved visual appearance of the plant, reduced ethylene (reduced production and/or inhibition of reception), improved quality of harvested material, e.g. seeds, fruits, leaves, vegetables (such improved quality may manifest as improved visual appearance of the harvested material), improved carbohydrate content (e.g. increased quantities of sugar and/or starch, improved sugar acid ratio, reduction of reducing sugars, increased rate of development of sugar), improved protein content, improved oil content and composition, improved nutritional value, reduction in anti-nutritional compounds, improved organoleptic properties (e.g. improved taste) and/or improved consumer health benefits (e.g. increased levels of vitamins and anti-oxidants)), improved post-harvest characteristics (e.g. enhanced shelf-life and/or storage stability, easier processability, easier extraction of compounds), more homogenous crop development (e.g. synchronised germination, flowering and/or fruiting of plants), and/or improved seed quality (e.g. for use in following seasons). A plant with improved quality may have an increase in any of the aforementioned traits or any combination or two or more of the aforementioned traits.

According to the present invention, an ‘improved tolerance to stress factors’ means that certain traits are improved qualitatively or quantitatively when compared with the same trait in a control plant which has been grown under the same conditions in the absence of the method of the invention. Such traits include, but are not limited to, an increased tolerance and/or resistance to abiotic stress factors which cause sub-optimal growing conditions such as drought (e.g. any stress which leads to a lack of water content in plants, a lack of water uptake potential or a reduction in the water supply to plants), cold exposure, heat exposure, osmotic stress, UV stress, flooding, increased salinity (e.g. in the soil), increased mineral exposure, ozone exposure, high light exposure and/or limited availability of nutrients (e.g. nitrogen and/or phosphorus nutrients). A plant with improved tolerance to stress factors may have an increase in any of the aforementioned traits or any combination or two or more of the aforementioned traits. In the case of drought and nutrient stress, such improved tolerances may be due to, for example, more efficient uptake, use or retention of water and nutrients.

Any or all of the above crop enhancements may lead to an improved yield by improving e.g. plant physiology, plant growth and development and/or plant architecture. In the context of the present invention ‘yield’ includes, but is not limited to, (i) an increase in biomass production, grain yield, starch content, oil content and/or protein content, which may result from (a) an increase in the amount produced by the plant per se or (b) an improved ability to harvest plant matter, (ii) an improvement in the composition of the harvested material (e.g. improved sugar acid ratios, improved oil composition, increased nutritional value, reduction of anti-nutritional compounds, increased consumer health benefits) and/or (iii) an increased/facilitated ability to harvest the crop, improved processability of the crop and/or better storage stability/shelf life. Increased yield of an agricultural plant means that, where it is possible to take a quantitative measurement, the yield of a product of the respective plant is increased by a measurable amount over the yield of the same product of the plant produced under the same conditions, but without application of the present invention. According to the present invention, it is preferred that the yield be increased by at least 0.5%, more preferred at least 1%, even more preferred at least 2%, still more preferred at least 4%, preferably 5% or even more.

Any or all of the above crop enhancements may also lead to an improved utilisation of land, i.e. land which was previously unavailable or sub-optimal for cultivation may become available. For example, plants which show an increased ability to survive in drought conditions, may be able to be cultivated in areas of sub-optimal rainfall, e.g. perhaps on the fringe of a desert or even the desert itself.

In one aspect of the present invention, crop enhancements are made in the substantial absence of pressure from pests and/or diseases and/or abiotic stress. In a further aspect of the present invention, improvements in plant vigour, stress tolerance, quality and/or yield are made in the substantial absence of pressure from pests and/or diseases. For example pests and/or diseases may be controlled by a pesticidal treatment that is applied prior to, or at the same time as, the method of the present invention. In a still further aspect of the present invention, improvements in plant vigour, stress tolerance, quality and/or yield are made in the absence of pest and/or disease pressure. In a further embodiment, improvements in plant vigour, quality and/or yield are made in the absence, or substantial absence, of abiotic stress.

The plant, plant propagation material or locus thereof may be treated with a combination of the invention before the material is sown or planted. Alternatively, the plant, plant propagation material or locus thereof may be treated with a combination of the invention after the material is sown or planted. Additionally, the combination of the invention may be applied to the previously treated propagation material, either before its planting, and/or at its planting and/or during its growth.

Typically, the treatment of the soil with a combination of the invention, whether as a single composition or as individual components, can occur on several occasions during the growth of a plant up to the harvest (i.e. before its planting, and/or at its planting and/or during its growth). The treatment of a single composition and then the individual components in succession is also envisaged during the growth of a plant.

The combination of the invention may be applied to the locus of the plant on one or more occasions during the growth of the plant. It can be applied to the planting site before the seed is sown, during the sowing of the seed, pre-emergence and/or post-emergence. The combination can also be used while the plant is being grown in a green house and the use can be continued after transplantation. The soil may, for example, be treated directly, prior to transplanting, at transplanting or after transplanting.

The use of the combination of the invention can be via any suitable method, which ensures that the agents penetrate the soil, for example, nursery tray application, in furrow application, soil drenching, soil injection, drip irrigation, application through sprinklers or central pivot, incorporation into soil (broad cast or in band) are such methods.

The rate and frequency of use of the combination of the invention on the plant may vary within wide limits and depends on the type of use, the specific active agents, the nature of the soil, the method of application (pre- or post-emergence, etc.), the plant to be controlled, the prevailing climatic conditions, and other factors governed by the method of application, the time of application and the target plant.

In the event the components of the invention are applied individually, the time elapse between applications of the components to the locus of the plant should be such that on application of the second component the improved plant growth characteristics are demonstrated. The order of the application of the components is not critical. The second component is applied within preferably 14, such as 10, for example, 5, more preferably 4, especially 3, advantageously 1, days of the first component. Most preferably, the components are applied simultaneously or sequentially.

Typical rates of application are normally from 1 g to 2 kg of active ingredient (a.i.) per hectare (ha), preferably from 5 g to 1 kg a.i./ha, more preferably from 20 g to 600 g a.i./ha, yet more preferably from 50 g to 200 g a.i./ha. Most preferably, the rate of application of the compound of formula (I) is 50 g to 200 g/ha, and the rate of application of plant activator is from 5 g to 50 g/ha.

When used as seed drenching agent, convenient rates of application are from 10 mg to 1 g of active substance per kg of seeds.

In an additional aspect, the present invention provides an agrochemical composition comprising a combination of a compound of formula (I), (II), (III) or (IV) and a plant activator, in a ratio of 10 to 40 parts compound of formula (I), (II), (III) or (IV) to 1 to 10 parts plant activator, by weight, together with an agrochemically acceptable diluent or carrier. In a preferred embodiment, the present invention provides an agrochemical composition comprising a combination of a compound of formula (Ia), (Ib), (Ic), (Id), (Ie), (II), (III) or (IV), and acibenzolar, acibenzolar-S-methyl or probenazole, in a ratio of 10 to 40 parts compound of formula (I) to 1 to 10 parts plant activator, by weight, together with an agrochemically acceptable diluent or carrier. In a most preferred embodiment, the present invention provides an agrochemical composition comprising a combination of cyantraniliprole and acibenzolar-S-methyl, in a ratio of 10 to 40 parts compound of formula (I), (II), (III) or (IV) to 1 to 10 parts plant activator, by weight, together with an agrochemically acceptable diluent or carrier.

Accordingly, in a first preferred aspect, the present invention provides a method of reducing insect-vectored viral infection in a plant by application of a combination of a compound of formula (Ia), (Ib), (Ic), (Id), (Ie), (II), (III) or (IV), and acibenzolar-S-methyl.

Plant activators suitable for use in the methods of the present invention include, for example, acibenzolar, acibenzolar-S-methyl

In additional aspects, the present invention provides a synergistic combination of a compound of formula (I), (II), (III) or (IV) and a plant activator for use in the methods of the present invention.

The compound of formula (I), (II), (III) or (IV) may be applied once or on several occasions in combination with the plant activator during the growth of a plant depending on the plant and circumstances, for example, 1 to 6 or 1 to 4 occasions, and the amounts indicated above for a compound of formula (I), (II), (III) or (IV) and plant activator are application rates are for each application.

The term “plant propagation material” is understood to denote all the generative parts of the plant, such as seeds, which can be used for the multiplication of the latter and vegetative plant material such as cuttings and tubers (for example, potatoes). There may be mentioned, e.g., the seeds (in the strict sense), roots, fruits, tubers, bulbs, rhizomes, parts of plants. Germinated plants and young plants, which are to be transplanted after germination or after emergence from the soil, may also be mentioned. These young plants may be protected before transplantation by a total or partial treatment by immersion.

Further, the present invention is also applicable for use with a plant propagation material, e.g. plant seed that has already undergone a treatment with a pesticide.

Even distribution of the combination of the invention and adherence thereof to the seeds is desired during treatment of the propagation material, for example, a seed. The treatment could vary from a thin film of the formulation containing the combination of the invention on a plant propagation material, such as a seed, where the original size and/or shape are recognizable to a thick film (such as a coating or pelleting with many layers of different materials (such as carriers, for example, clays; different formulations, such as of active ingredients; polymers; and colourants) where the original shape and/or size of the seed is no longer recognisable.

Accordingly, in one embodiment the combination of the invention is adhered to the propagation material, such as a seed. In an alternative embodiment, the combination of the invention is present on the seed in a pellet form.

Although it is believed that the present method can be applied to a seed in any physiological state, it is preferred that the seed be in a sufficiently durable state that it incurs no damage during the treatment process. Typically, the seed would be a seed that had been harvested from the field; removed from the plant; and separated from any cob, stalk, outer husk, and surrounding pulp or other non-seed plant material. The seed would preferably also be biologically stable to the extent that the treatment would cause no biological damage to the seed. It is believed that the treatment can be applied to the seed at any time between harvest of the seed and sowing of the seed or during the sowing process (seed directed applications).

The seed treatment occurs to an unsown seed, and the term “unsown seed” is meant to include seed at any period between the harvest of the seed and the sowing of the seed in the ground for the purpose of germination and growth of the plant. Treatment to an unsown seed is not meant to include those practices in which the pesticide is applied to the soil but would include any application practice that would target the seed during the sowing/planting process.

The treated plant propagation material of the present invention can be treated in the same manner as conventional plant propagation material. The treated propagation material can be stored, handled, sowed and tilled in the same manner as any other pesticide treated material, such as seeds. Preferably, the treatment occurs before sowing of the seed so that the seed being sown or planted has been pre-treated.

The combinations, compositions and methods of the present invention may be used for the treatment of any plant including, for example, cereals (wheat, barley, rye, oats, maize (including field corn, pop corn and sweet corn), rice, sorghum and related crops); beet (sugar beet and fodder beet); leguminous plants (beans, lentils, peas, soybeans); oil plants (rape, mustard, sunflowers); cucumber plants (marrows, cucumbers, melons); fibre plants (cotton, flax, hemp, jute); vegetables (spinach, lettuce, asparagus, cabbages, carrots, eggplants, onions, pepper, tomatoes, potatoes, paprika, okra); plantation crops (bananas, fruit trees, rubber trees, tree nurseries), ornamentals (flowers, shrubs, broad-leaved trees and evergreens, such as conifers); as well as other plants such as vines, bushberries (such as blueberries), caneberries, cranberries, peppermint, rhubarb, spearmint, sugar cane and turf grasses including, for example, cool-season turf grasses (for example, bluegrasses (Poa L.), such as Kentucky bluegrass (Poa pratensis L.), rough bluegrass (Poa trivialis L.), Canada bluegrass (Poa compressa L.) and annual bluegrass (Poa annus L.); bentgrasses (Agrostis L.), such as creeping bentgrass (Agrostis palustris Huds.), colonial bentgrass (Agrostis tenius Sibth.), velvet bentgrass (Agrostis canina L.) and redtop (Agrostis alba L.); fescues (Festuca L.), such as tall fescue (Festuca arundinacea Schreb.), meadow fescue (Festuca elatior L.) and fine fescues such as creeping red fescue (Festuca rubra L.), chewings fescue (Festuca rubra var. commutate Gaud.), sheep fescue (Festuca ovine L.) and hard fescue (Festuca longifolia); and ryegrasses (Lolium L.), such as perennial ryegrass (Lolium perenne L.) and annual (Italian) ryegrass (Lolium multiflorum Lam.)) and warm-season turf grasses (for example, Bermudagrasses (Cynodon L. C. Rich), including hybrid and common Bermudagrass; Zoysiagrasses (Zoysia Willd.), St. Augustinegrass (Stenotaphrum secundatum (Walt.) Kuntze); and centipedegrass (Eremochloa ophiuroides (Munro.) Hack.)).

The combinations, compositions and methods of the present invention are particularly suitable for the treatment of crops, such as field crops, fruits, vegetables, nuts (particularly peanuts), berries, tropical plantations, ornamentals and others, such as wheat, barley, rye, oats, rice, maize, sorghum, beans, lentils, peas, soybeans, rape, mustard, poppy, sugar- and fodder-beet, cotton, flax, hemp, jute, sunflowers, castor oil, groundnuts, potatoes, tobacco, sugar cane, apples, pears, plums, peaches, nectarines, apricots, cherries, oranges, lemons, grapefruit, mandarins, olives vines, hops, almonds, walnuts, hazelnuts, avocado, bananas, tea, coffee, coconut, cocoa, natural rubber plants, oil plants, strawberries, raspberries, blackberries, spinach, lettuce, asparagus, cabbages, Chinese kale, carrots, onions, tomatoes, cucumbers, pepper, eggplants, melons, paprika, chilli, roses, chrysanthemums and carnations. The plants may also be genetically modified. The present invention may preferably be used in high pH (such as 7 to 8.5) soil types.

Suitable plants also include plants that have been rendered tolerant to herbicides like bromoxynil or classes of herbicides (such as HPPD inhibitors, ALS inhibitors; for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones (e.g. imazamox) by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady@, Herculex I® and LibertyLink®.

Suitable plants also include plants which have been so transformed by the use of recombinant DNA techniques that they are capable of synthesising one or more selectively acting toxins, such as are known from toxin-producing bacteria, especially those of the genus Bacillus.

Suitable plants also include plants which have been so transformed by the use of recombinant DNA techniques that they are capable of synthesising antipathogenic substances having a selective action, such as the so-called “pathogenesis-related proteins” (PRPs, see e.g. European patent application EP 0,392,225). Examples of such antipathogenic substances and transgenic plants capable of synthesising such antipathogenic substances are known, for example, from European patent applications EP 0,392,225 and EP 0,353,191 and International patent application WO 95/33818. The methods of producing such transgenic plants are generally known to the person skilled in the art and are described, for example, in the publications mentioned above.

The combinations, compositions and methods of the present invention as defined herein are particularly suitable for the treatment of tomato, tobacco, peanut and barley.

Accordingly, in a preferred embodiment, the present invention provides a method of reducing insect-vectored viral infection in a tomato, tobacco, peanut or barley plant by application of a combination of cyantraniliprole and acibenzolar-S-methyl.

In an additional preferred embodiment, the present invention provides a method of reducing insect-vectored viral transmission to or amongst tomato, tobacco, peanut or barley plants by application of a combination of cyantraniliprole and acibenzolar-S-methyl.

In a further preferred embodiment, the present invention provides a method of reducing damage to a tomato, tobacco, peanut or barley plant caused by one or more insect-vectored viral infections, by application of a combination of cyantraniliprole and acibenzolar-S-methyl.

In a further preferred embodiment, the present invention provides a method of improving the growth of a tomato, tobacco, peanut or barley plant by application of a combination of cyantraniliprole and acibenzolar-S-methyl.

In a further preferred embodiment, the present invention provides a method of increasing the yield of a tomato, tobacco, peanut or barley plant by application of a combination of cyantraniliprole and acibenzolar-S-methyl.

In a further preferred embodiment, the present invention provides a method of improving tomato, tobacco, peanut or barley plant vigour by application of a combination of cyantraniliprole and acibenzolar-S-methyl.

In a further preferred embodiment, the present invention provides a method of increasing the tolerance of a tomato, tobacco, peanut or barley plant to abiotic stress by application of a combination of cyantraniliprole and acibenzolar-S-methyl.

In additional preferred embodiments, the present invention provides a combination of cyantraniliprole and acibenzolar-S-methyl, for use in the methods of the present invention, wherein the plant is a tomato, tobacco, peanut or barley plant.

In further additional preferred embodiments, the present invention provides for the use of a combination of cyantraniliprole and acibenzolar-S-methyl, in the methods of the present invention, wherein the plant is a tomato, tobacco, peanut or barley plant.

In yet additional preferred embodiments, the present invention provides a kit of parts suitable for use in the methods of the present invention, comprising a first component comprising cyantraniliprole and a second component comprising acibenzolar-S-methyl, for the simultaneous, separate or sequential application to a plant, plant propagation material or locus thereof, wherein the plant is a tomato, tobacco, peanut or barley plant.

The present invention additionally provides a plant or plant propagation material treated with a combination of the invention as defined herein. In a preferred embodiment, the plant or plant propagation material is tomato, tobacco, peanut or barley. In a more preferred embodiment, the plant or plant propagation material is tomato, tobacco, peanut or barley, which has been treated with a combination of cyantraniliprole and acibenzolar-S-methyl.

The combinations, compositions and methods of the present invention are particularly suitable for the treatment of plants which are susceptible to damage by insect-vectored viral infections transmitted by whitefly, aphid, leafhopper or thrips, such as leaf curl virus, which may be transmitted by whitefly.

Accordingly, in a preferred embodiment, the present invention provides a method of reducing insect-vectored viral infection in a plant by application of a combination of cyantraniliprole and acibenzolar-S-methyl, wherein the plant is susceptible to damage by viral infections transmitted by whitefly, aphid, leafhopper or thrips.

In an additional preferred embodiment, the present invention provides a method of reducing insect-vectored viral transmission amongst plants by application of a combination of cyantraniliprole and acibenzolar-S-methyl, wherein the plant is susceptible to damage by viral infections transmitted by whitefly, aphid, leafhopper or thrips.

In a further preferred embodiment, the present invention provides a method of reducing damage to a plant caused by one or more viral infections transmitted by whitefly, aphid, leafhopper or thrips, by application of a combination of cyantraniliprole and acibenzolar-S-methyl.

In a further aspect, the present invention provides a method of reducing damage to a plant caused by one or more pests selected from whitefly, aphid, leafhopper and thrips, by application of a combination of a compound of formula (I) and a plant activator. In a preferred embodiment, the present invention provides a method of reducing damage to a plant caused by one or more pests selected from whitefly, aphid, leafhopper and thrips, by application of a combination of a compound of formula (Ia), (Ib), (Ic), (Id), (Ie), (II), (III) or (IV), and acibenzolar-S-methyl. In a more preferred embodiment, the present invention provides a method of reducing damage to a plant caused by one or more pests selected from whitefly, aphid, leafhopper and thrips, by application of a combination of chlorantraniliprole or cyantraniliprole, and acibenzolar-S-methyl. In a yet more preferred embodiment, the present invention provides a method of reducing damage to a plant caused by one or more pests selected from whitefly, aphid, leafhopper and thrips, by application of a combination of cyantraniliprole and acibenzolar-S-methyl.

In a further preferred embodiment, the present invention provides a method of improving the growth of a plant by application of a combination of cyantraniliprole and acibenzolar-S-methyl, wherein the plant is susceptible to damage by viral infections transmitted by whitefly, aphid, leafhopper or thrips.

In a further preferred aspect, the present invention provides a method of increasing the yield of a plant by application of a combination of cyantraniliprole and acibenzolar-S-methyl, wherein the plant is susceptible to damage by viral infections transmitted by whitefly, aphid, leafhopper or thrips.

In a further preferred aspect, the present invention provides a method of improving plant vigour by application of a combination of cyantraniliprole and acibenzolar-S-methyl, wherein the plant is susceptible to damage by viral infections transmitted by whitefly, aphid, leafhopper or thrips.

In a further preferred aspect, the present invention provides a method of improving the tolerance of plants to abiotic stress by application of a combination of cyantraniliprole and acibenzolar-S-methyl, wherein the plant is susceptible to damage by viral infections transmitted by whitefly, aphid, leafhopper or thrips.

In additional preferred aspects, the present invention a combination of cyantraniliprole and acibenzolar-S-methyl, for use in the methods of the present invention, wherein the plant is susceptible to damage by viral infections transmitted by whitefly, aphid, leafhopper or thrips.

In further additional preferred aspects, the present invention provides for the use of a combination of cyantraniliprole and acibenzolar-S-methyl, in the methods of the present invention, wherein the plant is susceptible to damage by viral infections transmitted by whitefly, aphid, leafhopper or thrips.

In yet additional preferred aspects, the present invention provides a kit of parts suitable for use in the methods of the present invention, comprising a first component comprising cyantraniliprole and a second component comprising acibenzolar-S-methyl, for the simultaneous, separate or sequential application to a plant, plant propagation material or locus thereof, wherein the plant is susceptible to damage by viral infections transmitted by whitefly, aphid, leafhopper or thrips.

In each and every aspect of the present invention, the combinations, compositions and methods of the present invention, as defined herein, are particularly suitable for the treatment of tomato, tobacco, peanut and barley, in order to protect them from damage by insect-vectored viral infections transmitted by whitefly, aphid, leafhopper or thrips.

Accordingly, the most preferred embodiments of each aspect of the present invention are as defined below.

A method of reducing insect-vectored viral infection in a tomato, tobacco, peanut or barley plant by application of a combination of cyantraniliprole and acibenzolar-S-methyl, wherein the plant is susceptible to damage by insect-vectored viral infections transmitted by whitefly, aphid, leafhopper or thrips.

A method of reducing insect-vectored viral transmission amongst tomato, tobacco, peanut or barley plants by application of a combination of cyantraniliprole and acibenzolar-S-methyl, wherein the plant is susceptible to damage by insect-vectored viral infections transmitted by whitefly, aphid, leafhopper or thrips.

A method of reducing damage to a tomato, tobacco, peanut or barley plant caused by one or more viral infections transmitted by whitefly, aphid, leafhopper or thrips, by application of a combination of cyantraniliprole and acibenzolar-S-methyl.

A method of reducing damage to a tomato, tobacco, peanut or barley plant caused by one or more pests selected from whitefly, aphid, leafhopper and thrips, by application of a combination of cyantraniliprole and acibenzolar-S-methyl.

A method of improving the growth of a tomato, tobacco, peanut or barley plant by application of a combination of cyantraniliprole and acibenzolar-S-methyl, wherein the plant is susceptible to damage by insect-vectored viral infections transmitted by whitefly, aphid, leafhopper or thrips.

A method of increasing the yield of a tomato, tobacco, peanut or barley plant by application of a combination of cyantraniliprole and acibenzolar-S-methyl, wherein the plant is susceptible to damage by insect-vectored viral infections transmitted by whitefly, aphid, leafhopper or thrips.

A method of improving tomato, tobacco, peanut or barley plant vigour by application of a combination of cyantraniliprole and acibenzolar-S-methyl, wherein the plant is susceptible to damage by insect-vectored viral infections transmitted by whitefly, aphid, leafhopper or thrips.

A method of improving the tolerance of tomato, tobacco, peanut or barley plants to abiotic stress by application of a combination of cyantraniliprole and acibenzolar-S-methyl, wherein the plant is susceptible to damage by insect-vectored viral infections transmitted by whitefly, aphid, leafhopper or thrips.

A synergisitic combination of cyantraniliprole and acibenzolar-S-methyl, for use in the methods of the present invention, wherein the plant is a tomato, tobacco, peanut or barley plant, which is susceptible to damage by insect-vectored viral infections transmitted by whitefly, aphid, leafhopper or thrips.

The use of a combination of cyantraniliprole and acibenzolar-S-methyl, in the methods of the present invention, wherein the plant is a tomato, tobacco, peanut or barley plant, which is susceptible to damage by insect-vectored viral infections transmitted by whitefly, aphid, leafhopper or thrips.

A kit of parts suitable for use in the methods of the present invention, comprising a first component comprising cyantraniliprole and a second component comprising acibenzolar-S-methyl, for the simultaneous, separate or sequential application to a plant, plant propagation material or locus thereof, wherein the plant is a tomato, tobacco, peanut or barley plant, which is susceptible to damage by insect-vectored viral infections transmitted by whitefly, aphid, leafhopper or thrips.

Normally, a grower in the management of his crop would use one or more other agronomic chemicals in addition to the combination of the present invention. Examples of agronomic chemicals include herbicides, pesticides, such as fungicides, herbicides, insecticides, bactericides, acaricides, nematicides, plant nutrients and plant fertilizers.

Accordingly, the present invention provides for the use of a combination or composition according to the present invention together with one or more herbicides, pesticides, plant nutrients or plant fertilizers.

Suitable examples of plant nutrients or plant fertilizers are calcium sulfate CaSO₄, calcium nitrate Ca(NO₃)₂.4H₂O, calcium carbonate CaCO₃, potassium nitrate KNO₃, magnesium sulfate MgSO₄, potassium hydrogen phosphate KH₂PO₄, manganese sulfate MnSO₄, copper sulfate CuSO₄, zinc sulfate ZnSO₄, nickel chloride NiCl₂, cobalt sulfate CoSO₄, potassium hydroxide KOH, sodium chloride NaCl, boric acid H₃BO₃ and metal salts thereof, Na₂MoO₄. The nutrients may be present in an amount of 5% to 50% by weight, preferably of 10% to 25% by weight or of 15% to 20% by weight each. Preferred additional nutrients are urea, melamine, potassium oxide, and inorganic nitrates. The most preferred additional plant nutrient is potassium oxide. Where the preferred additional nutrient is urea, it is present in an amount of generally 1% to 20% by weight, preferably 2% to 10% by weight or of 3% to 7% by weight.

Examples of herbicides include glyphosate, glufosinate, glyfosinate, imidazilinone, and STS system (sulfonylurea).

Examples of pesticides include spinosad, avermectin, such as the natural avermectins, A1a, A1b, A2a, A2b, B1a, B1b, B2a and B2b, which can be obtained from Streptomyces avermitilis, and avermectin monosaccharide derivatives, such as abamectin, doramectin, emamectin, eprinomectin, ivermectin and selamectin, and milbemycin derivatives, such as milbemectin, milbemycin oxime, moxidectin and SI0009.

Examples of nematicides are abamectin, carbamate nematicides (e.g. aldicarb, carbofuran, carbosulfan, oxamyl, aldoxycarb, ethoprop benomyl, alanycarb), organophosphorus nematicides (e.g. phenamiphos, fenamiphos, fensulfothion, terbufos, fosthiazate, phosphocarb, dichlofenthion, isamidofos, fosthietan, isazofos, ethoprophos, cadusafos, chlorpyrifos, heterophos, isamidofos, mecarphon, phorate, thionazin, triazophos, diamidafos, phosphamidon), methyl bromide, methyl iodide, carbon disulfide, 1,3-dichloropropene, chloropicrin, cytokinins, dazomet, DCIP, ethylene dibromide, GY-81, metam, methyl isocyanate, myrothecium verrucaria composition, flupyrazofos, benchlothiaz, [2-cyanoimino-3-ethylimidazolidin-1-yl]phosphonothioic acid O-ethyl S-propyl ester, and bacillus firmus.

Further suitable examples of pesticides that can be used include acephate, acetamiprid, acetoprole, aldicarb, alpha-cypermethrin, azinphos-methyl, azoxystrobin, benalaxyl, benalaxyl-M, benclothiaz, bendicoarb, benfuracarb, benomyl, bensultap, bifenthrin, bitertanol, boscalid, captan, carbendazim, carbaryl, carbofuran, carbosulfan, carboxin, carbpropamid, chlorothalonil, chlorpyrifos, chlorpyrifos-methyl, clothianidin, copper salts (such as copper sulfate, cuprous oxide, Bordeaux mixture, copper hydroxide, copper sulfate (tribasic), copper oxychloride and copper octanoate), cymoxanil, cypermethrin, cyproconazole, cyprodinil, cyromazine, dazomet, deltamethrin, diazinon, difenoconazole, dimethoate, dimoxystrobin, diniconazole, dinotefuran, Emamectin, endosulfan, ethaboxam, ethirimol, ethiprole, ethoprophos, famoxadone, fenamidone, fenamiphos, fenhexamid, fenpiclonil, fipronil, flonicamid, fluoxastrobin, fluazinam, fludioxonil, fluquinconazole, flutolanil, flutriafol, fonophos, fosetyl-aluminium, fuberidazole, furathiocarb, gamma-cyhalothrin, gamma-HCH, guazatine, heptenophos, hexaconazole, hymexazol, imazalil, imidacloprid, ipconazole, iprodione, isofenphos, lambda-cyhalothrin, mancozeb, maneb, metalaxyl, metalaxyl-M, metconazole, methiocarb, methyl-bromide, methyl-iodide, myclobutanil, nuarimol, omethoate, oxamyl, oxadixyl, oxine-copper, oxolinic acid, pencycuron, pefurazoate, phosmet, picoxystrobin, pirimicarb, prochloraz, procymidone, propamocarb, propiconazole, prothioconazole, pymetrozine, pyraclostrobin, pyrimethanil, pyroquilon, quintozene, silthiofam, spinosad, tebuconazole, tefluthrin, tetraconazole, thiabendazole, thiacloprid, thiamethoxam, thiodicarb, thiophanate-methyl, thiram, tolylfluanid, triadimenol, triazamate, triazophos, triazoxide, triticonazole, trifloxystrobin, 3-Iodo-N*2*-(2-methanesulfonyl-1,1-dimethyl-ethyl)-N*1*-[2-methyl-4-(1,2,2,2-tetrafluoro-1-trifluoromethyl-ethyl)-phenyl]-phthalamide (code NNI-0001), and a compound of 2-Pyridin-2-yl-2H-pyrazole-3-carboxylic acid (2-methylcarbamoyl-phenyl)-amide (code DKI-0001), such as 2-(3-Chloro-pyridin-2-yl)-5-trifluoromethyl-2H-pyrazole-3-carboxylic acid (4-chloro-2-isopropylcarbamoyl-6-methyl-phenyl)-amide, 2-(3-Chloro-pyridin-2-yl)-5-trifluoromethyl-2H-pyrazole-3-carboxylic acid (4-chloro-2-methyl-6-methylcarbamoyl-phenyl)-amide, 5-bromo-2-(3-chloro-pyridin-2-yl)-2H-pyrazole-3-carboxylic acid (4-chloro-2-isopropyl-carbamoyl-6-methyl-phenyl)-amide, 5-Bromo-2-(3-chloro-pyridin-2-yl)-2H-pyrazole-3-carboxylic acid (4-chloro-2-methyl-6-methylcarbamoyl-phenyl)-amide, and 3-Difluoromethyl-1-methyl-1 Hpyrazole-4-carboxylic acid (2-bicyclopropyl-2-yl-phenyl)-amide.

The combination of a compound of formula (I), (II), (III) or (IV) and a plant activator has been found to be particularly effective in reducing the damage to plants caused by whitefly, aphid, leafhopper and thrips and the viral infections transmitted thereby. The action of the compound of formula (I), (II), (III) or (IV) together with a plant activator goes far beyond their action individually. A synergistic effect exists whenever the action of, for example, the active ingredient combination of the compounds is greater than the sum of the actions of the active ingredients applied separately. This can be calculated, for example, by the Colby formula, as described in COLBY, S. R., “Calculating synergistic and antagonistic response of herbicide combinations”, Weeds 15, pages 20-22, 1967.

In the treatments or applications of the invention the components of the invention are generally in the form of a formulation containing other customary formulation adjuvants because it allows, for example, less burdensome handling and application.

A variety of formulation types exist: dry flowables (DF), liquid flowables (LF), true liquids (TL), emulsifiable concentrates (EC), suspension concentrates (SC), dusts (D), wettable powders (WP), suspoemulsions (SE), water-dispersible granules (WG) and others, such as encapsulations in polymeric substances. Some are registered for use only by commercial applicators using closed application systems; others are readily available for on-farm use as dusts, slurries, water-soluble bags, or liquid ready-to-apply formulations. Normally however, commercial products are usually formulated as concentrates, where the end user will normally employ dilute formulations. How the components of the invention are to be used will also determine the formulation type, for example, if they are to be used as a seed treatment, then an aqueous composition is preferred.

The compound of formula (I), (II), (III) or (IV) and plant activator can be part of a single composition and used simultaneously (i.e. they are mixed together—often referred to as “a pre-mix”), or can be separate products and used separately or sequentially. In the event they are separate products, they can be mixed together shortly before use by the user.

It is often more practical, where possible, for commercially available formulations of the compound of formula (I), (II), (III) or (IV) and plant activator to be brought together in the desired mixing ratio in a container (often referred to as a “tank mixture”) in water shortly before application.

In an embodiment, the compound of formula (I), (II), (III) or (IV) and plant activator are used in single composition that has been specifically formulated, the composition comprising at least one of the adjuvants customary in formulation technology, such as extenders, e.g., solvents or solid carriers, or surface-active compounds (surfactants).

Suitable formulation adjuvants are, for example, solid carriers, solvents, stabilisers, slow-release adjuvants, dyes and optionally surface-active substances (surfactants). Suitable carriers and adjuvants in this case include all substances customarily used in crop protection products, especially in products for controlling snails and slugs. Suitable adjuvants, such as solvents, solid carriers, surface-active compounds, non-ionic surfactants, cationic surfactants, anionic surfactants and further adjuvants in the compositions used in accordance with the invention are, for example, the same as those described in EP 0,736,252.

The compositions may comprise from 0.1 to 99%, in particular 0.1 to 95%, of the combination and from 1 to 99.9%, in particular 5 to 99.9%, of at least one solid or liquid auxiliary. The composition may additionally comprise from 0 to 25%, in particular 0.1 to 20%, of surfactants (% is in each case percent by weight). While concentrated compositions are more preferred as commercial goods, the end user generally uses dilute compositions that comprise considerably lower concentrations of the combination.

Preferred compositions are composed, in particular, as follows (%=percent by weight):

### Emulsifiable Concentrates:

combination: 1 to 90%, preferably 5 to 20%
surfactant: 1 to 30%, preferably 10 to 20%
solvent: balance

### Dusts:

combination: 0.1 to 10%, preferably 0.1 to 1%
solid carrier: 99.9 to 90%, preferably 99.9 to 99%

### Suspension Concentrates:

combination: 5 to 60%, preferably 10 to 40%
surfactant: 1 to 40%, preferably 2 to 30%
water: balance

### Wettable Powders:

combination: 0.5 to 90%, preferably 1 to 80%
surfactant: 0.5 to 20%, preferably 1 to 15%
solid carrier: balance

### Granules:

combination: 0.5 to 60%, preferably 3 to 40%
solid carrier: 99.5 to 70%, preferably 97 to 85%

The compositions may also comprise further solid or liquid adjuvants, such as stabilisers, e.g., vegetable oils or epoxidised vegetable oils (e.g., epoxidised coconut oil, rapeseed oil or soybean oil), antifoams, e.g., silicone oil, preservatives, viscosity regulators, binders and/or tackifiers.

The following Examples are given by way of illustration and not by way of limitation of the invention.

### EXAMPLES

Trial results of cyantraniliprole/azibenzolar applications to control tomato yellow leaf curl virus (TYLC) in tomatoes.

### 1. Foliar Use Method:

Two studies were carried out in Elhasanya, Egypt in 2009 on tomato plants of the variety Fayrouz with the main goal to measure efficacy on the whitefly Bemisia tabaci. The plot size was 4.8 m² and 6 replicates were used in the trial. Products were applied 3 times on young tomato plants at BBCH stages 14, 17 and 51 at spray intervals between 12 and 19 days. The spray volume was at the first application 350 l/ha and later 500 l/ha. The evaluation of this study was done counting the adult whiteflies (Bemisia tabaci) as well as the nymphs and the eggs in each plot. In addition to the direct whitefly effect, visual symptoms of the virus, mainly TYLCV (tomato yellow leaf curl virus) were evaluated also.

ASM=Acibenzolar-S-methyl. WG 50=Actigard® 50WG, a water-dispersible granule with the active ingredient ASM
CYNT=Cyantraniliprole. WG 40=Cyazypyr®, a water dispersable granule with the active ingredient CYNT.
Results on whitefly adults. Trial 1

| | | | % Efficacy on Adults | | | | | | | | |
|---|---|---|---|---|---|---|---|---|---|---|---|
| | | | 5D | 10D | 5D | 10D | 5D | 10D | 15D | 20D | Avg |
| Product | Form. | g ai/hl | AA1 | AA1 | AA2 | AA2 | AA3 | AA3 | AA3 | AA3 | % C |
| ASM | WG 50 | 12.5 | 53 | 43 | 45 | 37 | 55 | 46 | 38 | 12 | 41 |
| ASM | WG 50 | 25 | 59 | 43 | 52 | 39 | 57 | 49 | 40 | 22 | 45 |
| CYNT | WG 40 | 75 | 82 | 49 | 69 | 67 | 83 | 79 | 71 | 62 | 70 |
| CYNT | | 100 | 89 | 74 | 89 | 86 | 90 | 86 | 80 | 68 | 83 |
| CYNT | WG 40 | 75 | 54 | 33 | 78 | 74 | 88 | 83 | 77 | 67 | 69 |
| + | + | + | | | | | | | | | |
| ASM | WG 50 | 12.5 | | | | | | | | | |
| CYNT | | 100 | 82 | 69 | 92 | 89 | 94 | 90 | 84 | 70 | 84 |
| + | | + | | | | | | | | | |
| ASM | | 12.5 | | | | | | | | | |
| CYNT | WG 40 | 75 | 47 | 33 | 89 | 86 | 95 | 90 | 85 | 74 | 75 |
| + | + | + | | | | | | | | | |
| ASM | WG 50 | 25 | | | | | | | | | |
| CYNT | | 100 | 81 | 64 | 93 | 93 | 97 | 93 | 91 | 83 | 87 |
| + | | + | | | | | | | | | |
| ASM | | 25 | | | | | | | | | |
| Spirom | SC 240 | 150 | 61 | 43 | 71 | 69 | 81 | 76 | 67 | 54 | 65 |
| esifen | | | | | | | | | | | |

Number of adults in untreated check (from 60 random leaves per treatment):

| 5DAA1 | 10DAA1 | 5DAA2 | 10DAA2 | 5DAA3 | 10DAA3 | 15DAA3 | 20DAA3 |
|---|---|---|---|---|---|---|---|
| 249 | 270 | 540 | 895 | 1171 | 1200 | 950 | 410 |

Results on whitefly adults. Trial 2

| | | % Efficacy on Adults | | | | | | | | |
|---|---|---|---|---|---|---|---|---|---|---|
| | | | 5D | 10D | 5D | 10D | 5D | 10D | 15D | 20D |
| Product | Form. | g ai/hl | AA1 | AA1 | AA2 | AA2 | AA3 | AA3 | AA3 | AA3 |
| ASM | WG 50 | 12.5 | 53 | 43 | 45 | 37 | 55 | 46 | 38 | 12 |
| ASM | WG 50 | 25 | 59 | 43 | 52 | 39 | 57 | 49 | 40 | 22 |
| CYNT | WG 40 | 75 | 82 | 49 | 69 | 67 | 83 | 79 | 71 | 62 |
| CYNT | | 100 | 89 | 74 | 89 | 86 | 90 | 86 | 80 | 68 |
| CYNT | WG 40 | 75 | 54 | 33 | 78 | 74 | 88 | 83 | 77 | 67 |
| + | + | + | | | | | | | | |
| ASM | WG 50 | 12.5 | | | | | | | | |
| CYNT | | 100 | 82 | 69 | 92 | 89 | 94 | 90 | 84 | 70 |
| + | | + | | | | | | | | |
| ASM | | 12.5 | | | | | | | | |
| CYNT | WG 40 | 75 | 47 | 33 | 89 | 86 | 95 | 90 | 85 | 74 |
| + | + | + | | | | | | | | |
| ASM | WG 50 | 25 | | | | | | | | |
| CYNT | | 100 | 81 | 64 | 93 | 93 | 97 | 93 | 91 | 83 |
| + | | + | | | | | | | | |
| ASM | | 25 | | | | | | | | |
| Spiromesifen | SC 240 | 150 | 61 | 43 | 71 | 69 | 81 | 76 | 67 | 54 |

Number of adults in untreated check (from 60 random leaves per treatment):

| 5DAA1 | 10DAA1 | 5DAA2 | 10DAA2 | 5DAA3 | 10DAA3 | 15DAA3 | 20DAA3 |
|---|---|---|---|---|---|---|---|
| 249 | 270 | 540 | 895 | 1171 | 1200 | 950 | 410 |

Results on whitefly nymphs. Trial 1

| | | | % Efficacy on Nymphs | | | | | | |
|---|---|---|---|---|---|---|---|---|---|
| | | g ai/ | 5D | 10D | 5D | 10D | 15D | 20D | Avg |
| Product | Form. | hl | AA2 | AA2 | AA3 | AA3 | AA3 | AA3 | % C |
| ASM | WG 50 | 12.5 | 5 | 52 | 62 | 46 | 42 | 27 | 39 |
| ASM | WG 50 | 25 | 57 | 65 | 66 | 53 | 55 | 39 | 56 |
| CYNT | WG 40 | 75 | 27 | 48 | 72 | 65 | 60 | 48 | 53 |
| CYNT | WG 40 | 100 | 73 | 73 | 84 | 78 | 68 | 56 | 72 |
| CYNT | WG 40 | 75 | 41 | 51 | 83 | 72 | 65 | 50 | 60 |
| + | + | + | | | | | | | |
| ASM | WG 50 | 12.5 | | | | | | | |
| CYNT | WG 40 | 100 | 75 | 75 | 86 | 81 | 73 | 65 | 76 |
| + | + | + | | | | | | | |
| ASM | WG 50 | 12.5 | | | | | | | |
| CYNT | WG 40 | 75 | 36 | 57 | 93 | 81 | 75 | 69 | 69 |
| + | + | + | | | | | | | |
| ASM | WG 50 | 25 | | | | | | | |
| CYNT | WG 40 | 100 | 66 | 67 | 94 | 87 | 81 | 76 | 78 |
| + | + | + | | | | | | | |
| ASM | WG 50 | 25 | | | | | | | |
| Spiro- | SC 240 | 150 | 86 | 85 | 88 | 84 | 81 | 76 | 83 |
| mesifen | | | | | | | | | |

Number of nymphs in untreated check (from 60 random leaves per treatment):

| 5DAA2 | 10DAA2 | 5DAA3 | 10DAA3 | 15DAA3 | 20DAA3 |
|---|---|---|---|---|---|
| 1044 | 750 | 482 | 620 | 718 | 615 |

Results on whitefly nymphs. Trial 2

| | | | % Efficacy on Nymphs | | | | | |
|---|---|---|---|---|---|---|---|---|
| | | | 5D | 10D | 5D | 10D | 15D | 20 |
| Product | Form. | g ai/hl | AA2 | AA2 | AA3 | AA3 | AA3 | DAA3 |
| ASM | WG 50 | 12.5 | 5 | 52 | 62 | 46 | 42 | 27 |
| ASM | WG 50 | 25 | 57 | 65 | 66 | 53 | 55 | 39 |
| CYNT | WG 40 | 75 | 27 | 48 | 72 | 65 | 60 | 48 |
| CYNT | | 100 | 73 | 73 | 84 | 78 | 68 | 56 |
| CYNT | WG 40 | 75 | 41 | 51 | 83 | 72 | 65 | 50 |
| + | + | + | | | | | | |
| ASM | WG 50 | 12.5 | | | | | | |
| CYNT | | 100 | 75 | 75 | 86 | 81 | 73 | 65 |
| + | | + | | | | | | |
| ASM | | 12.5 | | | | | | |
| CYNT | WG 40 | 75 | 36 | 57 | 93 | 81 | 75 | 69 |
| + | + | + | | | | | | |
| ASM | WG 50 | 25 | | | | | | |
| CYNT | | 100 | 66 | 67 | 94 | 87 | 81 | 76 |
| + | | + | | | | | | |
| ASM | | 25 | | | | | | |
| Spiromesifen | SC 240 | 150 | 86 | 85 | 88 | 84 | 81 | 76 |

Number of nymphs in untreated check (from 60 random leaves per treatment):

| 5DAA2 | 10DAA2 | 5DAA3 | 10DAA3 | 15DAA3 | 20DAA3 |
|---|---|---|---|---|---|
| 1044 | 750 | 482 | 620 | 718 | 615 |

Evaluation of percentage of infected leaf area by TYLC virus (average of 45 plants evaluated per treatment) Trial 1

| | | | % Infected Surface area with virus / plant, | | | | | |
|---|---|---|---|---|---|---|---|---|
| | | | produced from 45 plants / treatment | | | | | |
| | | Rate | 14.10 | 24.10 | 29.10 | 3.11 | 8.11 | 12.11 |
| Product | Form. | g ai/hl | 5DAA2 | 5DAA3 | 10DAA3 | 15DAA3 | 20DAA3 | 24DAA3 |
| Check | | | 0.9 | 2.5 | 15.1 | 17.0 | 19.4 | 23.8 |
| ASM | WG 50 | 12.5 | 0.0 | 1.0 | 9.6 | 9.9 | 10.7 | 14.4 |
| ASM | WG 50 | 25 | 0.0 | 0.0 | 3.3 | 4.7 | 5.0 | 7.2 |
| CYNT | WG 40 | 75 | 0.0 | 3.0 | 5.1 | 7.1 | 9.8 | 10.3 |
| CYNT | WG 40 | 100 | 0.8 | 1.9 | 3.1 | 3.9 | 4.5 | 5.3 |
| CYNT | WG 40 | 75 | 0.0 | 1.2 | 3.3 | 4.3 | 4.7 | 4.6 |
| + | + | + | | | | | | |
| ASM | WG 50 | 12.5 | | | | | | |
| CYNT | WG 40 | 100 | 0.0 | 1.3 | 1.3 | 2.2 | 2.3 | 2.8 |
| + | + | | | | | | | |
| ASM | WG 50 | 12.5 | | | | | | |
| CYNT | WG 40 | 75 | 0.0 | 1.8 | 2.3 | 3.6 | 3.8 | 4.1 |
| + | + | + | | | | | | |
| ASM | WG 50 | 25 | | | | | | |
| CYNT | WG 40 | 100 | 0.0 | 0.6 | 1.3 | 2.1 | 2.3 | 2.2 |
| + | + | + | | | | | | |
| ASM | WG 50 | 25 | | | | | | |
| Spiromesifen | SC 240 | 150 | 1.1 | 0.8 | 7.1 | 8.8 | 11.1 | 11.5 |

Evaluation of percentage of infected leaf area by TYLC virus (average of 45 plants evaluated per treatment). Trial 2

| | | | % Infected Surface area with virus / plant, | | | | | |
|---|---|---|---|---|---|---|---|---|
| | | | produced from 45 plants / treatment | | | | | |
| | | Rate | 14.10 | 24.10 | 29.10 | 3.11 | 8.11 | 12.11 |
| Product | Form. | g ai/hl | 5DAA2 | 5DAA3 | 10DAA3 | 15DAA3 | 20DAA3 | 24DAA3 |
| Check | | | 0.9 | 2.5 | 15.1 | 17.0 | 19.4 | 23.8 |
| ASM | WG 50 | 12.5 | 0.0 | 1.0 | 9.6 | 9.9 | 10.7 | 14.4 |
| ASM | WG 50 | 25 | 0.0 | 0.0 | 3.3 | 4.7 | 5.0 | 7.2 |
| CYNT | WG 40 | 75 | 0.0 | 3.0 | 5.1 | 7.1 | 9.8 | 10.3 |
| CYNT | WG 40 | 100 | 0.8 | 1.9 | 3.1 | 3.9 | 4.5 | 5.3 |
| CYNT | WG 40 | 75 | 0.0 | 1.2 | 3.3 | 4.3 | 4.7 | 4.6 |
| + | + | + | | | | | | |
| ASM | WG 50 | 12.5 | | | | | | |
| CYNT | WG 40 | 100 | 0.0 | 1.3 | 1.3 | 2.2 | 2.3 | 2.8 |
| + | + | + | | | | | | |
| ASM | WG 50 | 12.5 | | | | | | |
| CYNT | WG 40 | 75 | 0.0 | 1.8 | 2.3 | 3.6 | 3.8 | 4.1 |
| + | + | + | | | | | | |
| ASM | WG 50 | 25 | | | | | | |
| CYNT | WG 40 | 100 | 0.0 | 0.6 | 1.3 | 2.1 | 2.3 | 2.2 |
| + | + | + | | | | | | |
| ASM | WG 50 | 25 | | | | | | |
| Spiromesifen | SC 240 | 150 | 1.1 | 0.8 | 7.1 | 8.8 | 11.1 | 11.5 |

### Trial Results of Cyantraniliprole/Azibenzolar Applications

### 2. Soil Use Method:

Two soil applied studies were carried out in Elhasanya, Egypt in 2009 on tomato plants with the main goal to measure efficacy on the whitefly Bemisia tabaci. The plot size was 4.8 m² and 6 replicates were used in the trial. Products were applied once on young tomato plants at BBCH stage 14 as a drench. The spray volume was at the first application 350 l/ha. The evaluation of this study was done counting the adult whiteflies (Bemisia tabaci) as well as the nymphs and the eggs in each plot. In addition to the direct whitefly effect, visual symptoms of the virus, mainly TYLCV (tomato yellow leaf curl virus) were evaluated also.

Results on whitefly adults. Trial 1

| | | | % Efficacy on Adults | | | | | | | |
|---|---|---|---|---|---|---|---|---|---|---|
| Product | Form. | g ai/ha | 5DAA | 10DAA | 15DAA | 20DAA | 25DAA | 30DAA | 35DAA | 40DAA |
| ASM | WG 50 | 12.5 | 40 | 41 | 58 | 39 | 29 | 22 | 14 | 5 |
| ASM | WG 50 | 25 | 50 | 44 | 64 | 42 | 31 | 26 | 26 | 5 |
| CYNT | WG 40 | 100 | 79 | 75 | 78 | 72 | 66 | 61 | 53 | 39 |
| CYNT | WG 40 | 150 | 83 | 75 | 79 | 74 | 69 | 67 | 59 | 45 |
| CYNT | WG 40 | 100 | 84 | 71 | 74 | 74 | 69 | 63 | 51 | 44 |
| + | + | + | | | | | | | | |
| ASM | WG 50 | 12.5 | | | | | | | | |
| CYNT | WG 40 | 150 | 94 | 89 | 90 | 87 | 83 | 79 | 73 | 59 |
| + | + | + | | | | | | | | |
| ASM | WG 50 | 12.5 | | | | | | | | |
| CYNT | WG 40 | 100 | 92 | 84 | 85 | 83 | 79 | 71 | 63 | 50 |
| + | + | + | | | | | | | | |
| ASM | WG 50 | 25 | | | | | | | | |
| CYNT | WG 40 | 150 | 94 | 90 | 92 | 90 | 89 | 83 | 78 | 64 |
| + | + | + | | | | | | | | |
| ASM | WG 50 | 25 | | | | | | | | |

Number of adults in untreated check (from 60 random leaves per treatment):

| 5DAA | 10DAA | 15DAA | 20DAA | 25DAA | 30DAA | 35DAA | 40DAA |
|---|---|---|---|---|---|---|---|
| 218 | 255 | 332 | 516 | 991 | 1103 | 822 | 368 |

Results on whitefly adults. Trial 2

| | | | % Efficacy on Adults | | | | | | | |
|---|---|---|---|---|---|---|---|---|---|---|
| Product | FORM. | g ai/ha | 5DAA | 10DAA | 15DAA | 20DAA | 25DAA | 30DAA | 35DAA | 40DAA |
| ASM | WG 50 | 12.5 | 29 | 34 | 35 | 31 | 25 | 19 | 12 | 9 |
| ASM | WG 50 | 25 | 36 | 45 | 45 | 43 | 35 | 30 | 23 | 10 |
| CYNT | WG 40 | 100 | 70 | 71 | 76 | 74 | 72 | 65 | 57 | 43 |
| CYNT | WG 40 | 150 | 76 | 80 | 83 | 82 | 80 | 71 | 62 | 45 |
| CYNT | WG 40 | 100 | 77 | 74 | 79 | 79 | 75 | 66 | 58 | 46 |
| + | + | + | | | | | | | | |
| ASM | WG 50 | 12.5 | | | | | | | | |
| CYNT | WG 40 | 150 | 79 | 83 | 84 | 84 | 83 | 78 | 71 | 57 |
| + | + | + | | | | | | | | |
| ASM | WG 50 | 12.5 | | | | | | | | |
| CYNT | WG 40 | 100 | 81 | 84 | 83 | 80 | 78 | 73 | 66 | 57 |
| + | + | + | | | | | | | | |
| ASM | WG 50 | 25 | | | | | | | | |
| CYNT | WG 40 | 150 | 84 | 86 | 86 | 87 | 84 | 79 | 77 | 60 |
| + | + | + | | | | | | | | |
| ASM | WG 50 | 25 | | | | | | | | |

Number of adults in untreated check (from 60 random leaves per treatment):

| 5DAA | 10DAA | 15DAA | 20DAA | 25DAA | 30DAA | 35DAA | 40DAA |
|---|---|---|---|---|---|---|---|
| 418 | 580 | 657 | 680 | 710 | 776 | 828 | 869 |

Results on whitefly nymphs. Trial 1

| | | | % Efficacy on Nymphs | | | | | | |
|---|---|---|---|---|---|---|---|---|---|
| Product | Form. | g ai/ha | 10DAA | 15DAA | 20DAA | 25DAA | 30DAA | 35DAA | 40DAA |
| ASM | WG 50 | 12.5 | 47 | 21 | 31 | 60 | 47 | 41 | 28 |
| ASM | WG 50 | 25 | 50 | 47 | 54 | 50 | 49 | 44 | 33 |
| CYNT | WG 40 | 100 | 67 | 65 | 59 | 39 | 28 | 24 | 13 |
| CYNT | WG 40 | 150 | 69 | 84 | 84 | 77 | 74 | 70 | 64 |
| CYNT | WG 40 | 100 | 75 | 69 | 59 | 44 | 47 | 37 | 26 |
| + | + | + | | | | | | | |
| ASM | WG 50 | 12.5 | | | | | | | |
| CYNT | WG 40 | 150 | 72 | 90 | 86 | 83 | 80 | 78 | 73 |
| + | + | + | | | | | | | |
| ASM | WG 50 | 12.5 | | | | | | | |
| CYNT | WG 40 | 100 | 78 | 68 | 64 | 61 | 56 | 48 | 39 |
| + | + | + | | | | | | | |
| ASM | WG 50 | 25 | | | | | | | |
| CYNT | WG 40 | 15 | 82 | 92 | 90 | 87 | 83 | 80 | 76 |
| + | + | + | | | | | | | |
| ASM | WG 50 | 25 | | | | | | | |

Number of nymphs in untreated check (from 60 random leaves per treatment):

| 10DAA | 15DAA | 20DAA | 25DAA | 30DAA | 35DAA | 40DAA |
|---|---|---|---|---|---|---|
| 950 | 982 | 711 | 327 | 605 | 650 | 526 |

Results on whitefly nymphs. Trial 2

| | | | % Efficacy on Nymphs | | | |
|---|---|---|---|---|---|---|
| Product | Form. | g ai/ha | 25DAA1 | 30DAA1 | 35DAA1 | 40DAA2 |
| ASM | WG 50 | 12.5 | 29 | 39 | 22 | 11 |
| ASM | WG 50 | 25 | 69 | 43 | 14 | 6 |
| CYNT | WG 40 | 100 | 60 | 34 | 63 | 52 |
| CYNT | WG 40 | 150 | 78 | 79 | 77 | 61 |
| CYNT | WG 40 | 100 | 75 | 78 | 60 | 57 |
| + | + | + | | | | |
| ASM | WG 50 | 12.5 | | | | |
| CYNT | WG 40 | 150 | 77 | 80 | 73 | 63 |
| + | + | + | | | | |
| ASM | WG 50 | 12.5 | | | | |
| CYNT | WG 40 | 100 | 69 | 76 | 58 | 54 |
| + | + | + | | | | |
| ASM | WG 50 | 25 | | | | |
| CYNT | WG 40 | 150 | 83 | 91 | 72 | 65 |
| + | + | + | | | | |
| ASM | WG 50 | 25 | | | | |

Number of nymphs in untreated check (from 60 random leaves per treatment):

| 25DAA1 | 30DAA1 | 35DAA | 40DAA |
|---|---|---|---|
| 377 | 453 | 213 | 224 |

Evaluation of percentage of infected leaf area by TYLC virus (average of 45 plants evaluated per treatment). Trial 1

| | | | % Infected Surface area with virus / plant, | | | | | |
|---|---|---|---|---|---|---|---|---|
| | | | produced from 45 plants / treatment | | | | | |
| | | | 14.10 | 24.10 | 29.10 | 3.11 | 8.11 | 12.11 |
| Product | Form. | Rate g ai/hl | 15DAA | 25DAA | 30DAA | 35DAA | 40DAA | 44DAA |
| Check | | | 1.4 | 1.7 | 8.4 | 13.4 | 15.8 | 22.2 |
| ASM | WG 50 | 12.5 | 0.0 | 1.1 | 5.7 | 5.7 | 7.4 | 16.7 |
| ASM | WG 50 | 25 | 0.0 | 1.3 | 3.3 | 3.3 | 5.5 | 11.4 |
| CYNT | WG 40 | 100 | 1.1 | 1.3 | 4.3 | 5.9 | 7.4 | 19.9 |
| CYNT | WG 40 | 150 | 0.0 | 0.0 | 3.0 | 3.3 | 3.8 | 14.9 |
| CYNT | WG 40 | 100 | 0.0 | 1.8 | 2.2 | 2.2 | 3.1 | 10.2 |
| + | + | + | | | | | | |
| ASM | WG 50 | 12.5 | | | | | | |
| CYNT | WG 40 | 150 | 0.0 | 0.0 | 1.3 | 1.3 | 1.7 | 4.9 |
| + | + | + | | | | | | |
| ASM | WG 50 | 12.5 | | | | | | |
| CYNT | WG 40 | 100 | 1.1 | 1.6 | 1.7 | 1.7 | 1.7 | 2.5 |
| + | + | + | | | | | | |
| ASM | WG 50 | 25 | | | | | | |
| CYNT | WG 40 | 150 | 0.0 | 0.0 | 0.0 | 1.3 | 1.3 | 2.3 |
| + | + | + | | | | | | |
| ASM | WG 50 | 25 | | | | | | |

Evaluation of percentage of infected leaf area by TYLC virus (average of 45 plants evaluated per treatment). Trial 2

| | | | % Infected Surface area with virus / plant, | | | | |
|---|---|---|---|---|---|---|---|
| | | | produced from 45 plants / treatment | | | | |
| | | Rate | 19.11 | 24.11 | 29.11 | 4.12 | 9.12 |
| Product | Form. | g ai/hl | 30DAA | 35DAA | 40DAA | 45DAA | 50DAA |
| Check | | | 7.2 | 12.3 | 13.9 | 19.2 | 23.1 |
| ASM | WG 50 | 12.5 | 4.0 | 5.2 | 6.7 | 11.1 | 14.0 |
| ASM | WG 50 | 25 | 2.4 | 3.1 | 4.2 | 7.5 | 12.4 |
| CYNT | WG 40 | 100 | 3.8 | 5.2 | 6.5 | 12.9 | 15.5 |
| CYNT | WG 40 | 150 | 1.3 | 2.3 | 3.8 | 9.1 | 13.3 |
| CYNT | WG 40 | 100 | 1.8 | 2.1 | 4.0 | 8.4 | 11.3 |
| + | + | + | | | | | |
| ASM | WG 50 | 12.5 | | | | | |
| CYNT | WG 40 | 150 | 1.4 | 1.8 | 2.3 | 4.0 | 4.9 |
| + | + | + | | | | | |
| ASM | WG 50 | 12.5 | | | | | |
| CYNT | WG 40 | 100 | 1.2 | 1.6 | 1.8 | 1.8 | 2.3 |
| + | + | + | | | | | |
| ASM | WG 50 | 25 | | | | | |
| CYNT | WG 40 | 150 | 0.3 | 0.8 | 1.0 | 1.4 | 2.3 |
| + | + | + | | | | | |
| ASM | WG 50 | 25 | | | | | |

1. A method of reducing insect-vectored viral infection in a plant by application of a combination of an anthranilic bis-amide or an aminothiadiazole (ryanodine receptor modulator) insecticide of formula (I) 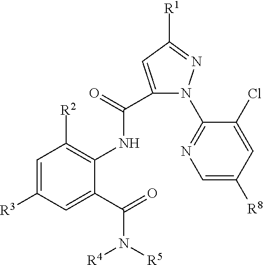
wherein
R₁ is halogen, C₁-C₄haloalkyl or C₁-C₄haloalkoxy;
R² is halogen or C₁-C₄alkyl;
R³ is halogen or cyano;
R⁴ is hydrogen or C₁-C₄alkyl;
R⁵ is hydrogen, C₁-C₄alkyl, C₃-C₄cycloalkyl-C₁-C₄alkyl, NR⁶R⁷
R⁶ is hydrogen or C₁-C₄alkyl; and
R⁷ is C(0)OC₁-C₄alkyl;
R⁸ is hydrogen or halogen;
or of a compound of formula II 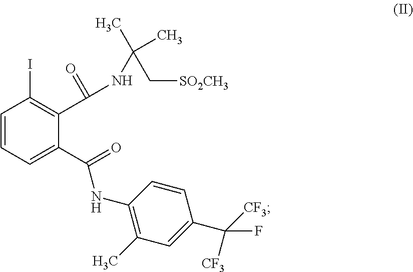 [SMILES: Cc1cc(C(F)(C(F)(F)F)C(F)(F)F)ccc1NC(=O)c1cccc(I)c1C(=O)NC(C)(C)CS(C)(=O)=O]
or of a compound of formula III 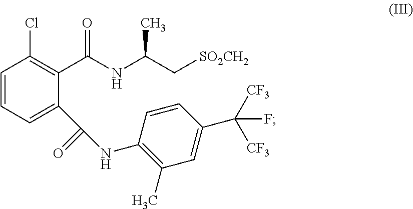
or an aminothiadiazole (ryanodine receptor modulator) compound of formula IV 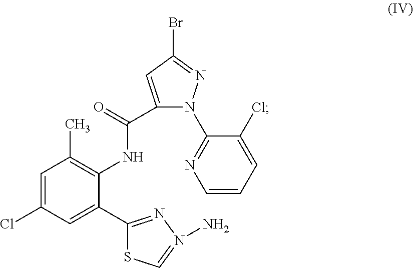
or an agrochemically acceptable salt thereof; and a plant activator.

2. A method of reducing insect-vectored viral infection in a plant, according to claim 1, by application of a combination of an anthranilic bis-amide insecticide of formula (I) 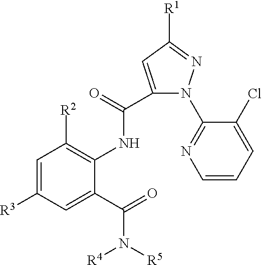
wherein
R₁ is halogen, C₁-C₄haloalkyl or C₁-C₄haloalkoxy;
R² is halogen or C₁-C₄alkyl;
R³ is halogen or cyano;
R⁴ is hydrogen or C₁-C₄alkyl;
R⁵ is hydrogen, C₁-C₄alkyl, C₃-C₄cycloalkyl-C₁-C₄alkyl, NR⁶R⁷
R⁶ is hydrogen or C₁-C₄alkyl; and
R⁷ is C(0)OC₁-C₄alkyl;
or an agrochemically acceptable salt thereof; and a plant activator.

3. A method of reducing insect-vectored-viral transmission amongst plants by application of a combination of at least one compound selected from the group consisting of a compound of formula (I), (II), (III) and (IV); and a plant activator.

4. A method of reducing damage to a plant caused by one or more insect-vectored viral infections, by application of a combination of at least one compound selected from the group consisting of a compound of formula (I), (II), (III) and (IV); and a plant activator.

5. A method of improving the growth of a plant by application of a combination of at least one compound selected from the group consisting of a compound of formula (I), (II), (III) and (IV) as defined in claim 1; and a plant activator.

6. A method of increasing the yield of a plant by application of a combination of at least one compound selected from the group consisting of a compound of formula (I), (II), (III) and (IV) as defined in claim 1; and a plant activator.

7. A method of improving plant vigour by application of a combination of at least one compound selected from the group consisting of a compound of formula (I), (II), (III) and (IV) as defined in claim 1; and a plant activator.

8. A method of improving the tolerance of plants to abiotic stress by application of a combination of at least one compound selected from the group consisting of a compound of formula (I), (II), (III) and (IV) as defined in claim 1; and a plant activator.

9. A method according to claim 1 wherein the compound of formula (I) is selected from:

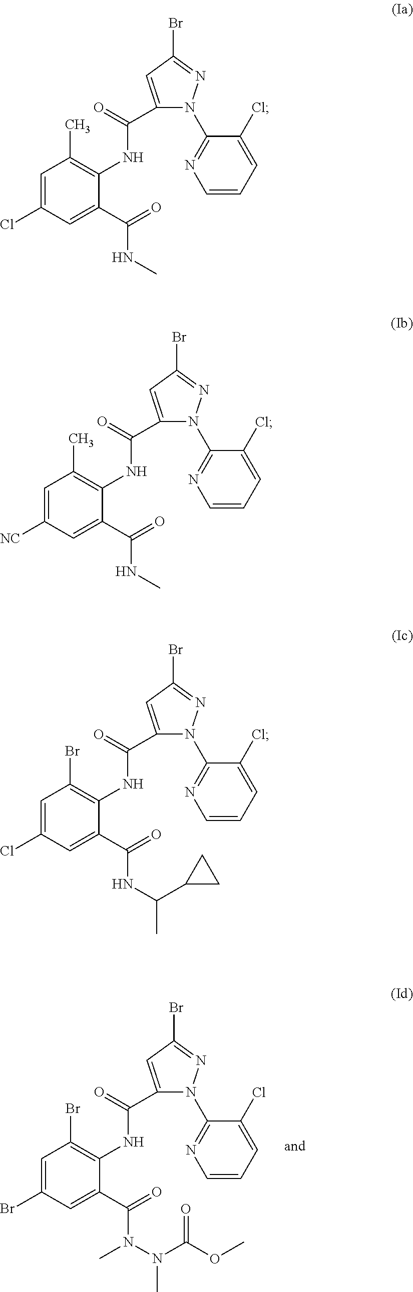 [SMILES: CNC(=O)c1cc(Cl)cc(C)c1NC(=O)c1cc(Br)nn1-c1ncccc1Cl ; CNC(=O)c1cc(C#N)cc(C)c1NC(=O)c1cc(Br)nn1-c1ncccc1Cl ; CC(NC(=O)c1cc(Cl)cc(Br)c1NC(=O)c1cc(Br)nn1-c1ncccc1Cl)C1CC1 ; COC(=O)N(C)N(C)C(=O)c1cc(Br)cc(Br)c1NC(=O)c1cc(Br)nn1-c1ncccc1Cl]

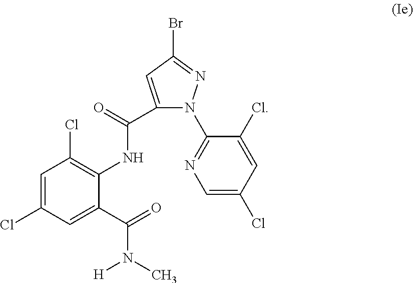 [SMILES: CNC(=O)c1cc(Cl)cc(Cl)c1NC(=O)c1cc(Br)nn1-c1ncc(Cl)cc1Cl]

10. A method according to any claim 8 wherein the compound of formula (I) is cyantraniliprole (Ib).

11. A method according to claim 1 wherein the plant activator is acibenzolar, acibenzolar-S-methyl or probenazole.

12. A method according to any claim 11 wherein the plant activator is acibenzolar-S-methyl.

13. A method according to claim 1 wherein the rate of application of the compound of formula (I), (II), (III) or (IV) is 50 g to 200 g/ha, and the rate of application of plant activator is from 5 g to 50 g/ha.

14. A method according to claim 1 wherein the plant is a crop plant selected from field crops fruits, vegetables, nuts, peanuts, berries, tropical plantations, ornamentals and others, such as wheat, barley, rye, oats, rice, maize, sorghum, beans, lentils, peas, soybeans, rape, mustard, poppy, sugar- and fodder-beet, cotton, flax, hemp, jute, sunflowers, castor oil, groundnuts, potatoes, tobacco, sugar cane, apples, pears, plums, peaches, nectarines, apricots, cherries, oranges, lemons, grapefruit, mandarins, olives vines, hops, almonds, walnuts, hazelnuts, avocado, bananas, tea, coffee, coconut, cocoa, natural rubber plants, oil plants, strawberries, raspberries, blackberries, spinach, lettuce, asparagus, cabbages, Chinese kale, carrots, onions, tomatoes, cucumbers, pepper, eggplants, melons, paprika, chilli, roses, chrysanthemums and carnations.

15. A method according to claim 14 wherein the plant is tomato, tobacco, peanut or barley.

16. A method according to claim 1 wherein the plant is susceptible to damage by viral infections transmitted by whitefly, aphid, leafhopper or thrips.

17. A method according to claim 1 wherein the plant, plant propagation material, or the locus thereof, is treated before its planting, and/or at its planting and/or during its growth.

18. A method according to claim 1 wherein the treatment is via nursery tray application, in furrow application, soil drenching, soil injection, drip irrigation, application through sprinklers or central pivot, or incorporation into the soil, such as via broad cast or in band.

19. A method according to claim 1 wherein the compound of formula (I) and the plant activator are applied simultaneously, separately or sequentially.

20. A method according to claim 1 wherein the compound of formula (I) and the plant activator are applied as one or more agrochemical compositions comprising an agrochemically acceptable diluent or carrier.

21. (canceled)

22. (canceled)

23. (canceled)

24. A plant or plant propagation material treated with a combination of a compound of formula (I) as defined claim 1, and a plant activator.

25. A composition comprising a compound of formula (I), (II), (III) or (IV) as defined claim 1, and a plant activator.
